(19) United States
(12) Patent Application Publication
(10) Pub. No.: US 2015/0003493 A1
(43) Pub. Date: Jan. 1, 2015

(54) OCCUPANCY SENSOR FOR OCCUPIABLE ITEM E.G. SEAT OR BED

(71) Applicant: IEE INTERATIONAL ELECTRONICS & ENGINEERING S.A., Echternach (LU)

(72) Inventors: Werner Bieck, Wiltingen (DE); Alain Schumacher, Igel (DE); Gunter Godert, Trier (DE)

(21) Appl. No.: 14/368,014

(22) PCT Filed: Dec. 21, 2012
(86) PCT No.: PCT/EP2012/076543

§ 371 Date: Jun. 23, 2014

(30) Foreign Application Priority Data
Dec. 21, 2011 (LU) 91923

(51) Int. Cl. B60N 2/00; G01G 19/414; B60R 21/015; G01K 7/25

(52) U.S. Cl. CPC B60N 2/002; G01K 7/25; G01G 19/414; B60R 21/015; B60R 2021/01516
USPC 374/51

(57) ABSTRACT

An occupancy sensor for detecting the occupancy state of an item occupiable by a human or animal occupant, e.g. a seat or a bed, the sensor including a thermistor, to be arranged in compression-dependent heat-conducting relationship with the occupiable item, and a control circuit operatively connected to the thermistor, where the control circuit is configured to derive an occupancy state of the occupiable item from a response of the thermistor to heat generated in or in vicinity of the thermistor.

### TECHNICAL FIELD

The present invention generally relates to sensing the occupancy state of an item occupiable by a human or animal occupant, such as e.g. an upholstery item like a seat (especially a car seat) or a bed (especially a hospital bed).

### BACKGROUND

Sensing the occupancy state is especially practiced in automotive vehicles in order to enable a seat belt reminder or to deactivate a secondary restraint system (airbags). Occupancy sensing has also been suggested for theatre or cinema seats or hospital beds.

Various sensor types have been proposed for detecting the presence or absence (i.e. the occupancy state) of an occupiable item. An important category includes pressure sensors, which are also referred to as weight or load sensors. Several sub-categories exist, like sensors using Reed switches, membrane sensors, pressure-sensitive resistors, fluid-filled bladder sensors, etc. Another category is that of capacitive occupancy sensors, which use an electrode to emit a weak alternating electric field into the space that an occupant would occupy and measure the capacitive coupling with a counter-electrode. In the automotive industry, capacitive sensors that are combined with a seat heater are considered especially interesting for the future. Yet another category comprises occupancy sensors relying on optical detection, e.g. a system including a camera and an image processor to extract the relevant information.

The present invention proposes a novel type of occupancy sensor.

### BRIEF SUMMARY

The invention relies on compression (due to an occupant's weight or to applied pressure) of an occupiable item or the sensor itself inducing a change of heat conduction properties of parts of the occupiable item and/or of the sensor itself. The sensor detects the occupancy state by measurement of the heat conduction properties or a parameter indicative thereof.

According to a first aspect of the invention, an occupancy sensor for detecting the occupancy state of an item occupiable by a human or animal occupant, e.g. a seat or a bed, comprises a thermistor, to be arranged in compression-dependent heat-conducting relationship with the occupiable item, and a control circuit operatively connected to the thermistor. The control circuit is configured to derive an occupancy state of the occupiable item from a response of the thermistor to heat generated in or in vicinity of the thermistor. The control circuit, which may be comprised of a microcontroller, an application-specific integrated circuit, or the like, is preferably configured to output an output signal indicative of the occupancy state that has been ascertained.

In the context of the present disclosure, the term “thermistor” generally designates a resistor whose resistance significantly varies with temperature. It is intended to encompass, in particular, ceramic, polymer or metal based resistive thermal devices with a positive or a negative temperature coefficient.

The control circuit may, for instance, be configured to derive the occupancy state of the occupiable item by comparing the response of the thermistor with one or more thresholds and selecting the occupancy state (to be output) among at least two predefined occupancy states (including at least “empty” and “occupied”) in accordance with an outcome of the comparison.

The control circuit may be configured to drive a current across the thermistor so as to generate the heat in the thermistor by resistive heating. The control circuit then monitors the response, e.g. the evolution of the resistance, of the thermistor, which results during and after the application of the current. The control circuit may, for instance comprise a current source, which it controls to apply a current pulse of a predefined duration. When the occupiable item is unloaded and thus uncompressed, the thermal conduction properties of its upholstery material (typically foam) are different as if the occupiable item is loaded. The thermistor may be in compression-dependent heat-conducting relationship with a foam padding of the occupiable item. When the foam is compressed, it will typically be able to conduct a certain heat quantity away from the thermistor in a shorter time as if the foam is relaxed. As a result, assuming a predefined current (in terms of intensity and duration) is applied, the thermistor will become hotter and remain hot for a longer time when the occupiable item is empty as if it is occupied. The control circuit may be configured to use different parameters to assess the occupancy state, for instance: the rise time of the resistance change (positive for a PTC thermistor, negative for an NTC thermistor) and/or the peak value of the resistance change and/or the decay time of the resistance change.

The occupancy sensor may comprise a heating element (separate from the thermistor) to be arranged in compression-dependent heat-conducting relationship with the occupiable item and at least indirectly, possibly only indirectly, in compression-dependent heat-conducting relationship with the thermistor. In this case, the heat, which the thermistor's responds to by a change of resistance, is generated by the heating element. The heating element may, for instance, comprise an ohmic or a thermoelectric heating element controlled by the control circuit. In such an embodiment of the invention, the heat need not be generated by the thermistor itself, as described above, but is produced by the heating element. Apart from that, the control circuit may detect the occupancy state as described above: as the heating element at least indirectly in compression-dependent heat-conducting relationship with the thermistor (e.g. via a part of the occupiable item such as a piece of upholstery material or the like), heat will be conducted differently between the heating element and the thermistor, depending on the occupancy state of the occupiable item.

The control circuit may be operatively connected to the heating element so as to control the generation of the heat. Alternatively, the control circuit can be operatively connected to the heating element so as be informed of the generation of the heat. In this case, the control circuit would not actively control the heating element, which would be controlled by another entity. However, the control circuit of the occupancy sensor would be able to take into account any resistance variations of the thermistor due to the heating element. Those skilled in the art will appreciate that this embodiment of the invention is especially useful if the occupiable item comprises a heating element in addition to the occupancy sensor. This may be frequently the case in seats of automotive vehicles. Not providing for informing the occupancy sensor of the functioning of the heating element could lead to erroneous measurements. In case the heating element is produced by another manufacturer, the control circuit of the occupancy sensor preferably comprises an interface for connecting it with the heating element and/or with the control device of the heating element and/or between the control device of the heating element.

According to a second aspect of the invention, an occupancy sensor for detecting the occupancy state of an item occupiable by a human or animal occupant, comprises a thermistor, a heat sink or source and a control circuit. The thermistor is arranged in compression-dependent heat-conducting relationship with the heat sink or source. The control circuit is operatively connected to the thermistor and configured to derive an occupancy state of the occupiable item from a response of the thermistor to heat generated in the thermistor and/or to heat generated or absorbed in the heat source or sink, respectively. As will be appreciated, an occupancy sensor in accordance with the second aspect of the invention operates using essentially the same principle as an occupancy sensor in accordance with the first aspect of the invention. However, according to the second aspect, the occupancy sensor includes a heat sink or source arranged in compression-dependent heat-conducting relationship with the thermistor. A compression-dependent heat-conducting relationship between the thermistor and the occupiable item is not required according to the second aspect of the invention but it is, nevertheless, possible. The thermistor and the heat sink or source could e.g. be separated by compressible material (e.g. foam or rubber or the like) whose heat conduction properties change with the degree of compression or simply by a gap that is reduced under compression.

The heat sink or source may comprise a heating element, e.g. a resistive heater or a thermoelectric heater. Alternatively or additionally, the heat sink or source may comprise a cooling element, e.g. a thermoelectric cooler. Apart from such active heating or cooling devices, the heat sink or source could comprise a heat reservoir, i.e. an object with a high thermal capacity in comparison with the thermistor, like a mass of metal or a gel- or liquid-filled bladder, the frame of the occupiable item (if one is provided), etc. It shall be noted that with a passive heat sink or source, it is not necessary that the heat sink or source remain at exactly the same temperature during the measurement. Neither is it necessary that the heat source or sink keep the same temperature from one measurement to the other.

According to a preferred embodiment of the invention, the occupiable item is a seat and the heat sink or source is arranged in heat-conducting contact with the seat, e.g. with a seating surface or a seat frame of the seat. As will be appreciated, the occupant of the seat could become part of the heat sink or source, when he is seated.

The thermistor may be a PTC (positive temperature coefficient) thermistor or an NTC (negative temperature coefficient) thermistor.

In embodiments, in which the thermistor is also used for comfort-heating of the occupiable item, the thermistor is preferably a PTC thermistor for it possesses self-regulating properties.

The term “comfort-heating” is used to designate a heating process that aims at achieving a temperature increase for the benefit of the occupant's comfort. In contrast, “diagnostic-heating” designates a heating that is primarily used for the purposes of the occupancy state detection in accordance with the present invention. Diagnostic heating does not necessarily have to result in a noticeable change of the temperature of the occupiable surface of the occupiable item. Nevertheless, comfort-heating and diagnostic-heating are not necessarily mutually exclusive. Some users of the present invention may, however, prefer embodiments of the occupancy sensor, in which diagnostic-heating is as little noticeable as possible by an occupant. If comfort-heating of the occupiable item is desired, a single device may be provided for comfort-heating and diagnostic heating or separate devices may be used.

According to a preferred embodiment under the first or the second aspect of the invention, the occupiable item is a seat (e.g. a car seat) and the (separate) heating element is a seat heater (i.e. used for comfort-heating and for diagnostic-heating, possibly in separate heating modes).

In embodiments in which the thermistor is used as a heating element, it may also be configured for comfort-heating and diagnostic heating. According to a preferred embodiment under the first or the second aspect of the invention, the occupiable item is a seat (e.g. a car seat) and the thermistor is a seat heater

The heat that is generated to induce a response from the thermistor is preferably a predefined quantity of heat or a measured quantity of heat.

The response of the thermistor to a temperature increase or decrease is a change of its electrical resistance. This does not imply however, that the resistance has to be measured directly. Any measurable quantity indicative of the resistance may in principle be used by the control circuit in order to assess the thermistor's response. The control circuit could e.g. apply a current and measure the voltage necessary for achieving the current. The control circuit could also apply a voltage and measure the resulting current across the thermistor.

A preferred aspect of the invention regards an occupiable item, preferably an upholstered occupiable item such as, e.g., a car seat, comprising an occupancy sensor as described.

Yet a further aspect of the present invention regards a pressure sensor, comprising a thermistor, a heat sink or source and a control circuit, the thermistor arranged in compression-dependent heat-conducting relationship with the heat sink or source, the control circuit operatively connected to the thermistor and configured to derive pressure information from a response of the thermistor to heat generated in the thermistor and/or to heat generated or absorbed in the heat source or sink, respectively. As will be understood, the pressure sensor may be configured essentially as the occupancy sensor in accordance with the second aspect of the invention. Instead of an occupancy state, the control circuit of the pressure sensor is configured to output a signal indicative of pressure exerted on the pressure sensor. It will be appreciated that a pressure sensor according to the aspect of the invention may be used as an occupancy sensor if the pressure signal output by the control circuit is indicative of an occupancy state.

### BRIEF DESCRIPTION OF THE DRAWINGS

Further details and advantages of the present invention will be apparent from the following detailed description of several not limiting embodiments with reference to the attached drawings, wherein:

FIG. 1 is a schematic view of a car seat equipped with an occupancy sensor according to a first preferred embodiment of the invention;

FIG. 2 is a schematic view of the car seat of FIG. 1 when occupied by a person defining an additional heat sink or source;

FIG. 3 is a graph illustrating the basic principle of operation of the invention;

FIG. 4 is a schematic cross sectional view of pressure sensor, in unloaded condition, according to a second preferred embodiment of the invention;

FIG. 5 is a schematic cross sectional view of the pressure sensor of FIG. 4 in loaded condition;

FIG. 6 is a perspective schematic view of an occupancy sensor according to a third preferred embodiment of the invention;

FIG. 7 is a schematic view of a car seat equipped with a seat heater the heating element of which is used to sense the occupancy state of the seat in accordance with a fourth embodiment of the invention;

FIG. 8 is a schematic illustration of an occupancy sensor according to yet another preferred embodiment of the invention.

### DETAILED DESCRIPTION

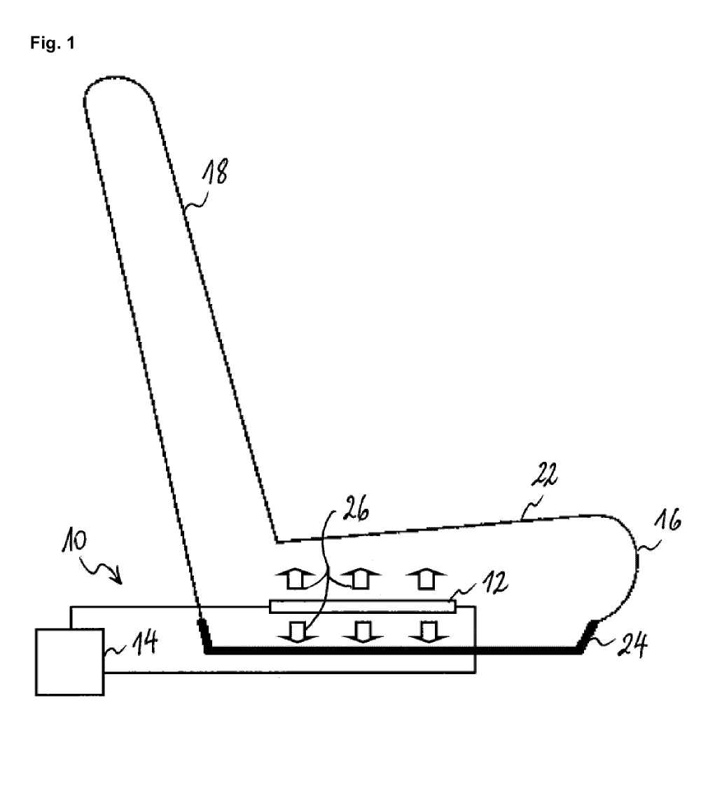

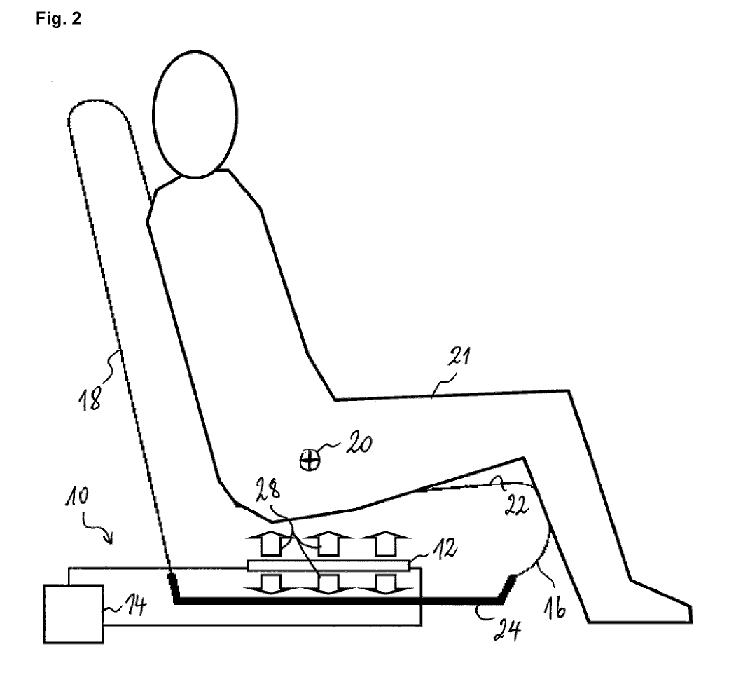

An occupancy sensor in accordance with a first embodiment of the invention is generally indicated at 10 in FIGS. 1 and 2. The occupancy sensor 10 comprises a thermistor 12 having its first and second terminals connected to a control circuit 14. The thermistor 10 is arranged in the seating portion 16 of a car seat 18. Specifically, the thermistor 10 is disposed substantially under the so-called H-point (or hip point) 20 (see FIG. 2) of an average occupant (e.g. a 50^{th} percentile male occupant) 21. The thermistor 10 may a priori be arranged at any depth between the trim cover 22 on the upper surface of the seating portion 16 and the seat support 24 (e.g. the seat pan or the springs, which carry the padding). A precise position within the seating portion may nevertheless be prescribed in accordance with the specifications of the seat manufacturer or the car manufacturer.

In accordance with the first aspect of the invention, the thermistor 12 is arranged in compression-dependent heat-conducting relationship with the car seat. When the seat 18 is occupied, the seat portion 22, more specifically the padding thereof, is compressed. This increases the capacity of the padding material to conduct heat towards and away from the thermistor 12. Small thermal conductivity in the unoccupied state of the seat 18 is represented in FIG. 1 by the small arrows 26. Increased thermal conductivity in the occupied state of the seat 18 is represented in FIG. 2 by the large arrows 28.

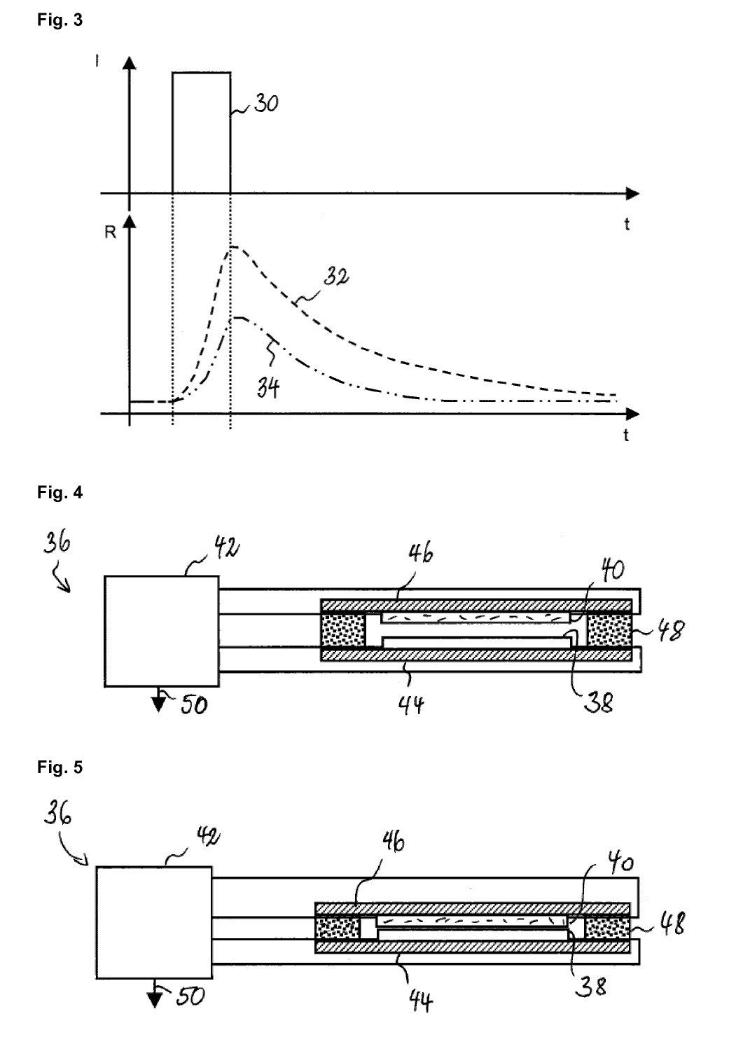

In the illustrated embodiment, the control circuit 14 carries out occupant detection as follows. For sake of this description, the thermistor 12 is supposed to be a PTC thermistor but an NTC thermistor could equally well be used. The control circuit 14 drives a current pulse 30 (FIG. 3) across the thermistor 12. The current pulse leads to diagnostic heating of the thermistor 12. The current pulse 30 is of known duration and intensity. At the same time, the control circuit 14 monitors the electrical resistance of the thermistor 12. FIG. 3 qualitatively illustrates the evolution of thermistor resistance in time when the seat is empty (dashed curve 32) and when it is occupied (dash-dotted curve 34). When the seat 18 is unloaded, the overall thermal conductivity of the seat material around the thermistor 12 is comparatively small (or normal). As a consequence, heat produced in the thermistor 12 due to the current 30 cannot be carried away quickly, which causes the temperature of the thermistor 12 to rise. As a PTC thermistor is assumed, the resistance increases with increasing temperature. The temperature increases until the current pulse is over or an equilibrium is reached between the heat generated in the thermistor and the heat carried away by heat conduction. In contrast, when the seat is loaded (occupied), the overall thermal conductivity is higher. With the same current pulse being applied, the temperature of the thermistor rises more slowly and maximum temperature (at the end of the current pulse or at thermal equilibrium) is lower. When the current pulse is over, the thermistor also cools down more quickly than in the unoccupied state of the seat.

In order to determine the occupancy state of the seat 18, the control circuit preferably compares at least one of the following parameters with a threshold: rise time (e.g. defined as the time required for the resistance to rise to a predefined value above the initial value), the maximum resistance and the decay time (e.g. defined as the time required to drop to a predefined percentage of the maximum resistance value).

It is worthwhile noting that the occupancy sensor 10 illustrated in FIGS. 1 and 2 also falls within the second aspect of the invention described above, in the sense that the material of the seat forms a heat sink into which the heat generated during the diagnostic-heating dissipates. Specifically, the seat support 24 may serve as a heat sink when the thermistor 12 is arranged sufficiently close to it.

FIGS. 4 and 5 are illustrations of a pressure sensor 36 in accordance with a second preferred embodiment of the invention. The pressure sensor 36 comprises a thermistor 38, a resistive heating element 40 representing a controllable heat source and a control circuit 42. The thermistor 38 is formed a thin printed layer on a first carrier film 44. The heating element 40 is formed by a thin printed layer of resistive ink on a second carrier film 46. The first and second carrier 44, 46 films are spaced apart by a spacer layer 48. The heating element 40 and the thermistor 38 are arranged in facing relationship. When pressure is applied to the pressure sensor, the heating element 40 and the thermistor 38 are brought closer together as the spacer layer 48 is compressed (FIG. 5). That changes the heat-conducting relationship between the heating element 40 and the thermistor 38. The control circuit determines the amount of pressure applied to the pressure sensor by measuring the change of electrical resistance of the thermistor 38 in response to generation of heat via the heating element 40. The control circuit 42 may achieve this as follows: it applies a current pulse of a predefined duration and amplitude to the heating element 40. At the same time and after the end of the pulse it monitors the electrical resistance of the thermistor 38. The closer the thermistor 38 is to the heating element 40, the prompter and more pronounced the changes in resistance. The response of the thermistor 38 may be analogous to that illustrated in FIG. 3. The output signal 50 produced by the control circuit 42 indicates at least a low pressure state and a high pressure state. Intermediate states may be indicated when the control circuit 42 is configured accordingly.

In the embodiment illustrated in FIGS. 4 and 5, the thermistor 38 and the heating element 40 are arranged in an opening in the spacer layer 48. When the pressure sensor is compressed, the air gap between the thermistor and the heating element is reduced. With a compressible spacer layer 48 (e.g. made of foam) as shown, the spacer layer could also be continuous, provided that its thermal conductivity changes with the degree of compression. It shall also be appreciated that the carrier films may be replaced by carrier plates (e.g. made of a plastic material) when the spacer layer is compressible. One could also use a substantially incompressible spacer layer. In this case, however, the spacer layer has to comprise an opening or at least a recess between the thermistor and the heating element and at least one of the carriers has to be sufficiently flexible for being bent towards the other carrier.

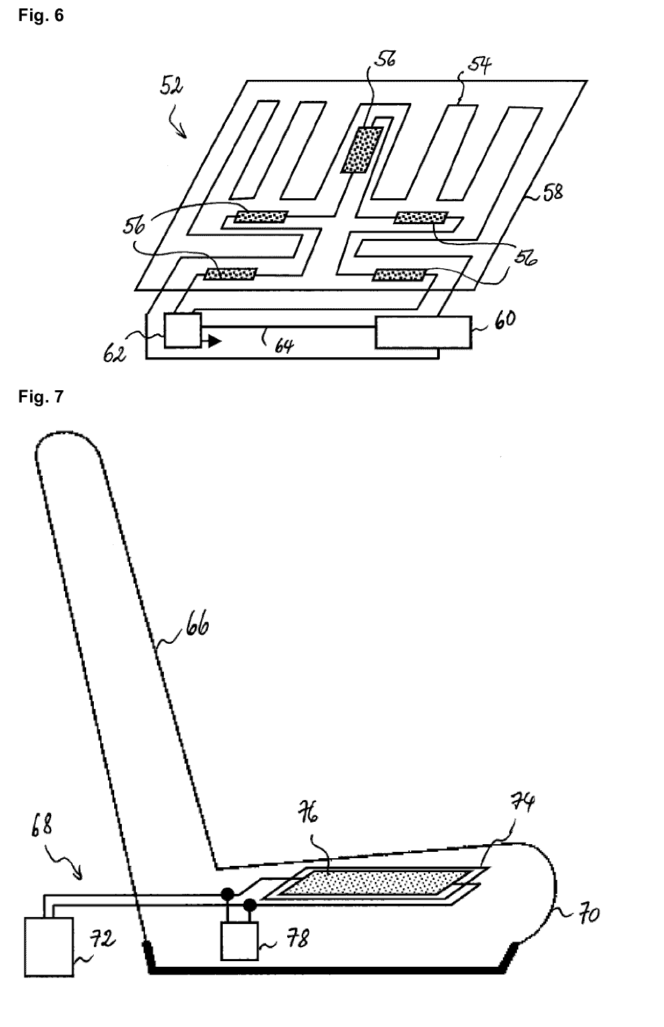

FIG. 6 illustrates a combined seat heating and occupancy sensing device 52, e.g. for a vehicle seat. The device 52 comprises a resistive heating element 54 for comfort-heating of a seat and a plurality of thermistors 56 arranged on a sheet substrate 58, e.g. a plastic carrier film. The heating element 54 and the thermistors 56 are preferably protected by a cover sheet (not shown) applied over them and fixed to the sheet substrate 58.

The resistive heating element 54 may comprise a resistive wire, cable fiber, bundle of fibers or a printed resistive layer. The heating element 54 may be made of PTC material, which has a self-regulation effect on the temperature of the heating element and improves the seating comfort. The heating current across the heating element 54 is controlled by a heater control unit 60.

The thermistors 56 are connected in series to a control circuit 62, which monitors the resistance of the series connection in order to determine the occupancy state of the seat, in which the sheet-type device including the heating element 54 and the thermistors is arranged.

The seat heating and occupancy sensing device 52 is preferably arranged in the seating portion of a seat, e.g. like the occupancy sensor 12 of FIGS. 1 and 2. Specifically, the seat heating and occupancy sensing device 52 is to be arranged in compression-dependent heat-conducting relationship with the seat.

The control circuit 62 is preferably configured to function in different modes of operation, depending e.g. on whether the seat heater is in ON or OFF state (in terms of comfort-heating). The heater control unit 60 is connected to the control circuit 62 via a communication line 64. The control circuit 62 is informed via this communication line 64 whether the heater control unit is driving a heating current across the heating element 54. If the heating power can be selected, the control circuit 62 also receives an indication, which power level is activated.

If the heater is ON, the control circuit 62 may correlate the evolution of the measured resistance with the information about the heating current in order to assess the occupancy state. On that basis, the control circuit 62 may, in particular, estimate the rate of the heat flow away from the seat heating and occupancy sensing device 52. If the estimated heat flow rate exceeds a certain threshold, the control circuit 62 may conclude that the seat is occupied and, if the estimated heat flow rate is below that threshold, the control circuit 62 may conclude that the seat is not occupied.

If the seat heater is in OFF state (in terms of comfort heating), the control circuit 62 may communicate with the heater control unit 60 in order to cause it to produce one or more diagnostic-heating pulses on the heating element 54. The control circuit 62 may then detect the occupancy state based upon the response of the series connection of the thermistors 56 to the diagnostic heating pulses. The quantity of heat released during each heating pulse is preferably sufficiently small for not being noticeable by the seat occupant (if present).

FIG. 7 schematically illustrates a vehicle seat 66 equipped with a seat heater 68 arranged in the seating portion 70 of the vehicle seat 66. The seat heater 68 comprises a heater control unit 72 and a heating element 74 arranged below the seat trim. The heating element 74 comprises a layer of PTC material 76. An occupancy sensor control circuit 78 is connected to the heating element 74. The PTC material 76 of the heating element 74 is a thermistor in the sense of the present disclosure. It is arranged in compression-dependent heat-conducting relationship with the seat 66 (which represents a heat sink for any heat generated by the heating element). The occupancy sensor control circuit 78 monitors the resistance across the heating element 74 and derives the occupancy state from these observations.

When comfort-heating by the seat heater 68 is on, the occupancy sensor control circuit 78 estimate the rate of the heat flow away from the heating element 76 based on the resistance measurement. When comfort-heating by the seat heater 68 is off, the occupancy sensor control circuit 78 generates a current pulse having predefined or measured characteristics (amplitude and duration) which induces a diagnostic-heating pulse. During the application of the current pulse and for some time thereafter, the occupancy sensor control circuit 78 monitors the resistance of the heating element 74 and derives the occupancy state from these observations.

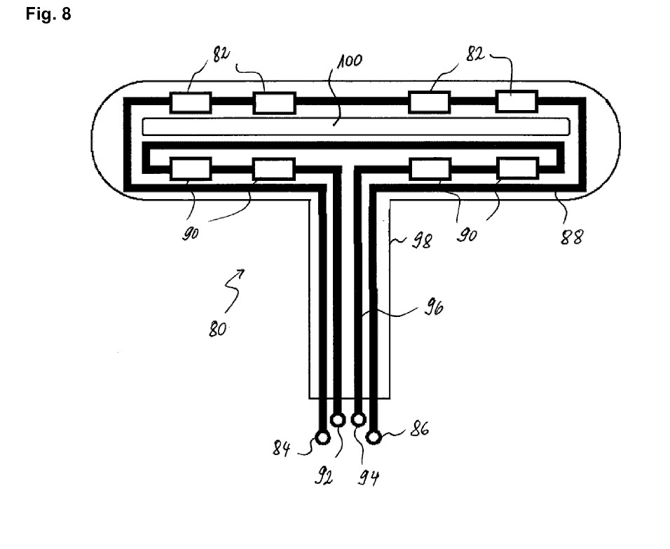

FIG. 8 schematically illustrates an occupancy sensor 80 according to yet another preferred embodiment of the invention. The occupancy sensor 80 comprises a plurality of thermistors 82 connected in series between a first 84 and a second 86 terminal of a sensing circuit 88, and a plurality of heating elements 90 connected in series between a first 92 and a second 94 terminal of a heating circuit 96. The (PTC or NTC) thermistors 82 and the heating elements 90 are disposed as printed electronic components on a common carrier film 98. The thermistors 82 and the heating elements 90 are separated from each other by an opening 100 (in this case a cutout) arranged in the carrier film 98. The opening 100 serves to thermally isolate the region of the carrier film 98 that carries the thermistors 82 from the region of the carrier film 98 that carries the heating elements 90. When the occupancy sensor is integrated into an occupiable item, the thermistors 82 and the heating elements 90 are both arranged in compression-dependent heat-conducting relationship with the occupiable item. Indirectly, the thermistors 82 and the heating elements 90 are thus mutually in compression-dependent heat-conducting relationship.

When the occupiable item (not shown) is occupied, its compression causes the heat flow rate between the heating elements 90 and the thermistors 82 to increase via the padding of the occupiable item. The control circuit (not shown) connected to the terminals 84, 86, 92, 94 may evaluate the occupancy state of the occupiable item as described hereinabove, e.g. with reference to FIG. 6. The heating circuit 96 may be configured for diagnostic-heating only or for both comfort-heating and diagnostic-heating.

While specific embodiments have been described in detail, those skilled in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

1. An occupancy sensor for detecting the occupancy state of an item occupiable by a human or animal occupant, e.g. a seat or a bed, comprising a thermistor, said thermistor being configured as a heating element for comfort-heating of said occupiable item to be arranged in compression-dependent heat-conducting relationship with said occupiable item, and a control circuit operatively connected to said thermistor, said control circuit configured to derive an occupancy state of said occupiable item from a response of said thermistor to heat generated in or in vicinity of said thermistor.

2. The occupancy sensor as claimed in claim 1, wherein said control circuit is configured to derive said occupancy state of said occupiable item by comparing said response of said thermistor with one or more thresholds and selecting said occupancy state among at least two predefined occupancy states in accordance with an outcome of said comparison.

3. The occupancy sensor as claimed in claim 1, wherein said control circuit is configured to drive a current across said thermistor so as to generate said heat in said thermistor by resistive heating.

4. The occupancy sensor as claimed in claim 1, comprising a heating element to be arranged in compression-dependent heat-conducting relationship with said occupiable item and at least indirectly, possibly only indirectly, in compression-dependent heat-conducting relationship with said thermistor, wherein said heat is generated by said heating element.

5. Occupancy sensor as claimed in claim 4, wherein said control circuit is operatively connected to said second heating element so as to control the generation of said heat.

6. Occupancy sensor as claimed in claim 4, wherein said control circuit is operatively connected to said heating element so as be informed of the generation of said heat.

7. An occupancy sensor for detecting the occupancy state of an item occupiable by a human or animal occupant, comprising a thermistor, said thermistor being configured as a heating element for comfort-heating of said occupiable item, a heat sink or source and a control circuit, said thermistor arranged in compression-dependent heat-conducting relationship with said heat sink or source, said control circuit operatively connected to said thermistor and configured to derive an occupancy state of said occupiable item from a response of said thermistor to heat generated in said thermistor and/or to heat generated or absorbed in said heat source or sink, respectively.

8. Occupancy sensor as claimed in claim 10, wherein said heat sink or source comprises a heating element.

9. The occupancy sensor as claimed in claim 11, wherein said heating element comprises a resistive heater or a thermoelectric heater.

10. (canceled)

11. The occupancy sensor as claimed in claim 10, wherein said heat sink or source comprises a cooling element, e.g. a thermoelectric cooler.

12. The occupancy sensor as claimed in claim 10, wherein said occupiable item is a seat and wherein said heat sink or source is arranged in heat-conducting contact with said seat, e.g. with a seating surface or a seat frame of said seat.

13. The occupancy sensor as claimed in claim 10, wherein said thermistor is a PTC thermistor.

14. The occupancy sensor as claimed in claim 10, wherein said thermistor is an NTC thermistor.

15. (canceled)

16. The occupancy sensor as claimed in claim 1, wherein said heat is a predefined or a measured quantity of heat.

17. The occupancy sensor as claimed in claim 1, wherein said response is a change of electrical resistance of said thermistor.

18. An occupiable item, preferably an upholstered occupiable item such as, e.g., a car seat, comprising an occupancy sensor as claimed in claim 1.

19. (canceled)

20. The occupancy sensor as claimed in claim 4, wherein said heating element comprises a resistive heater or a thermoelectric heater.

21. The occupancy sensor as claimed in claim 1, wherein said thermistor is a PTC thermistor.

22. The occupancy sensor as claimed in claim 1, wherein said thermistor is an NTC thermistor.

23. The occupancy sensor as claimed in claim 7, wherein said heat is a predefined or a measured quantity of heat.

24. The occupancy sensor as claimed in claim 7, wherein said response is a change of electrical resistance of said thermistor.
